(19) United States
(12) Patent Application Publication
(10) Pub. No.: US 2018/0007541 A1
(43) Pub. Date: Jan. 4, 2018

(54) APPLYING RULES TO A DEVICE FROM A SERVICE DETECTED BY THE DEVICE

(71) Applicant: HEWLETT PACKARD ENTERPRISE DEVELOPMENT LP, Houston, TX (US)

(72) Inventors: Adi Kidron, Yehud (IL); Tomer Priel, Yehud (IL); Tsila Cochavi, Yehud (IL)

(21) Appl. No.: 15/544,125

(22) PCT Filed: Jan. 29, 2015
(86) PCT No.: PCT/US2015/013565

§ 371 Date: Jul. 17, 2017

(51) Int. Cl. H04W 8/18; H04W 4/02; H04W 48/04; H04W 88/02

(52) U.S. Cl. CPC H04W 8/186; H04W 48/04; H04W 4/02; H04W 88/02

(57) ABSTRACT

Examples disclosed herein allow rules to he applied to a device from a service detected by the device. In one example, upon entering a service area, a device detects a service associated with the service area, wherein the service comprises rules to enable or disable parameters on devices, and the device then extracts a set of the rules from the service. As an example, the extracted set of rules corresponds to a group the device is associated with. The device determines whether conditions set for the extracted set of rules are met by the device and, if the conditions are met, the device applies the extracted set of rules to the device until the device exits the service area.

### BACKGROUND

The emergence and popularity of electronic technology, and in particular communication-related technology, has made electronic devices a staple in today's marketplace. Examples of such electronic devices that are widely used include, but are not limited to, smartphones, tablet computers, notebook computers, media players, and digital cameras. With the proliferation of electronic devices in the marketplace, it is becoming increasingly difficult to control the use of electronic devices in various settings, for example, where it may not be desirable for such devices to be used.

### DRAWINGS

FIG. 1 illustrates a device that may move between a number of different services, according to an example;

FIG. 2 illustrates the device entenng a service area associated with a service, according to an example;

FIG. 3 is a block diagram depicting an example of components of an electronic device; and

FIG. 4 is a flowdiagram depicting steps to implement an example.

### DETAILED DESCRIPTION

Examples disclosed herein provide the ability for a service to control parameters on devices that meet certain criteria or conditions. Examples of such criteria may be based on location, time, special events, or a combination of conditions. By being able to control common parameters on a group of devices that meet the criteria, the group of devices may be treated as one device by the service. Examples of parameters that may be controlled by the service include, but are not limited to, sensors or various functions of the devices that may be enabled or disabled, such as a Wi-Fi radio or a camera.

By controlling common parameters on a group of devices, usage of the devices may be restricted according to limitations set by an administrator of the service. As a result, users of the devices may not be able to use the devices in a way that is prohibited by the service (e.g., camera function disabled on devices when in a museum). As it may be desirable for each service to control different parameters of devices, each service may have its own set of rules set by an administrator, to control the different parameters. As will be further described, when a device enters a service area and detects a service associated with the service area, the device may extract and apply the associated set of rules for that service, if certain conditions are met.

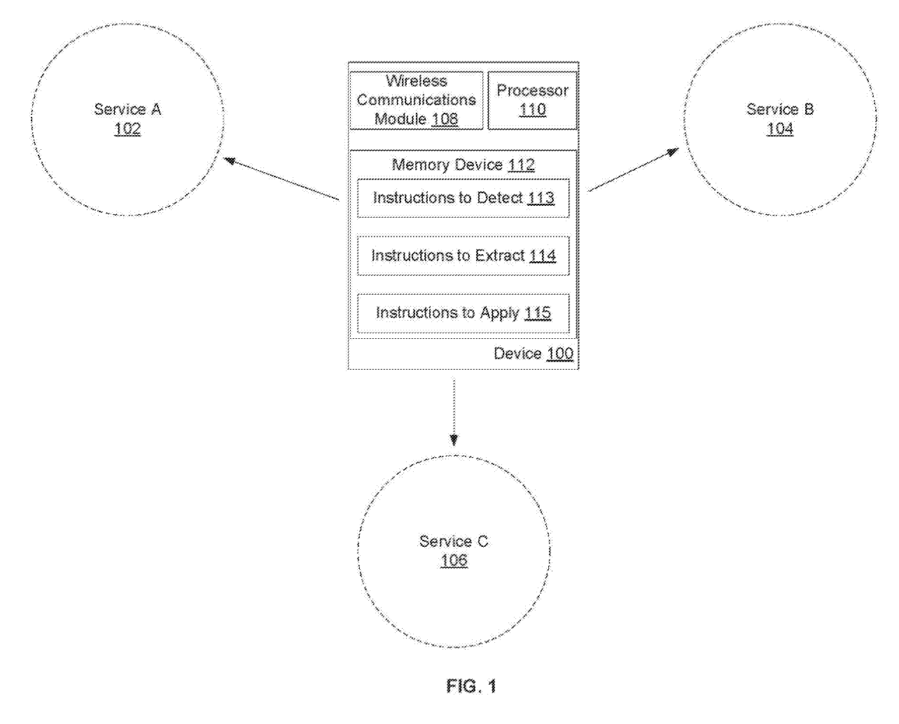

FIG. 1 illustrates a device 100 that may move between a number of different services, according to an example. Although three services are illustrated (service A 102, service B 104, and service C 106), more or less services may be included. Each service may have its own set of rules to control (e.g,, enable or disable) parameters on the device 100. For example, service A 102 may include rules 103, service B 104 may include rules 105, and service C 108 may include rules 107. As an example, the device 100 may include a wireless communications module 108 to communicate with a service. The wireless communications module 108 may include an antenna (not illustrated) to allow for transmission and receipt of wireless signals. The wireless communications module 108 can include a transceiver for transmitting and receiving signals.

As an example, order to detect a service, an agent or an application installed on the device 100 may detect the service when the device 100 enters a service area associated with the service. Examples of a service area include, but are not limited to, a geographical location or an area covered by an indoor positioning system, such as a beacon or a Wi-Fi access point. Referring to FIG. 1, the device 100 enters a service area associated with one of the services or be within range or proximity of one of the services when the device 100 enters one of the illustrated circles corresponding to the range of the different services. As an example, for a service area corresponding to a geographical location, the device 100 may enter the service area upon coming within proximity of a particular GPS location. As illustrated, each service may be located in different geographical locations. However, certain services may also overlap (not illustrated). For a service area corresponding to an area covered by an indoor positioning system, the device 100 may enter the service area upon coming within range of the indoor positioning system (e.g., detecting a beacon transmission).

The device 100 may be, for example, a laptop computer, desktop computer, tablet computer, mobile computing device, server, or cellular phone, a wearable computing device, retail point of sale device, gaming device, e-reader, or another computing device with wired and/or wireless transmission capability. The device 100 includes a processor 110 and a memory device 112. The components of the device 100 may be connected and communicate through a system bus (e.g., PCI, ISA, PCI-Express, HyperTransport®, NuBus, etc.).

As an example, the processor 110 is an instruction execution system that can fetch or obtain instructions and data from the memory device 112 and execute the instructions contained therein. The processor 110 can be a single core processor, a multi-core processor, a computing cluster, or any number of other configurations. The processor 110 may be implemented as Complex Instruction Set Computer (CISC) or Reduced Instruction Set Computer (RISC) processors, x86 Instruction set compatible processors, multi-core, or any other microprocessor or central processing unit (CPU). As an example, the main processor 110 includes dual-core processor(s), dual-core mobile processor(s), or the like.

As an example, the memory device 112 represents generally any number of memory components capable of storing instructions that can be executed by processor 110 to perform operations consistent with disclosed examples. As will be further described, the memory device 112 may include instructions 113 to detect a service, instructions 114 to extract a set of rules from the service, and instructions 115 to apply the extracted set of rules to the device 100 if certain conditions are met.

Memory device 112 is non-transitory in the sense that it does not encompass a transitory signal but instead is made up of one or more memory components configured to store the relevant instructions. As a result, the memory device 112 may be a non-transitory computer-readable storage medium. As an example, the memory device 112 can include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory systems.

In some examples, the instructions can be part of an installation package that, when installed, can be executed by the processor 110 to implement the operations. In such examples, the memory device 112 nay be a portable medium, such as a CD, DVD, or flash drive, or a memory maintained by a server from which the installation package can be downloaded and installed. In other examples, the instructions may be part of an application, applications, or component already installed on a server including the processor 110. In such examples, the memory device 112 may include memory such as a hard drive, solid state drive, or the like. In other examples, some or all of the functionalities described may be implemented in the form of electronic circuitry.

Referring back to FIG. 1, the device 100 can move in a number of directions, such as, for example, those illustrated in the figure (indicated by the arrows). Upon entering a service area associated with one of the services, the device 100 may include instructions 113 to detect the corresponding service. For example, once the device 100 enters an area covered by service A 102 (depicted by the circle), the device 100 may detect service A 102. As an example, device 100 may detect service A 102 upon entering a wireless network associated with service A 102. Similarly, device 100 may detect service A via other wireless communication methods, or by simply entering the geographical location associated with service A 102 (e.g., depicted by the circle), as described above. Upon detecting service A 102, the device 100 includes instructions 114 to extract a set of rules from the service. As will be further described, the device 100 may extract a set of rules that corresponds to a group the device 100 is associated with. If certain conditions are met, the device 100 includes instructions 115 to apply the extracted set of rules to the device 100 until the device 100 exits the service area associated with service A 102.

As illustrated, the device 100 may move between different geographical locations (e.g., indicated by the arrows), and detect corresponding services at the different locations. For example, device 100 may detect service A 102 at a first geographical location, service B 104 at a second geographical location, and service C 106 at a third geographical location. Upon detecting one, of the illustrated services, the device may apply a set of rules, as described above, until the device exits a service area associated with the detected service.

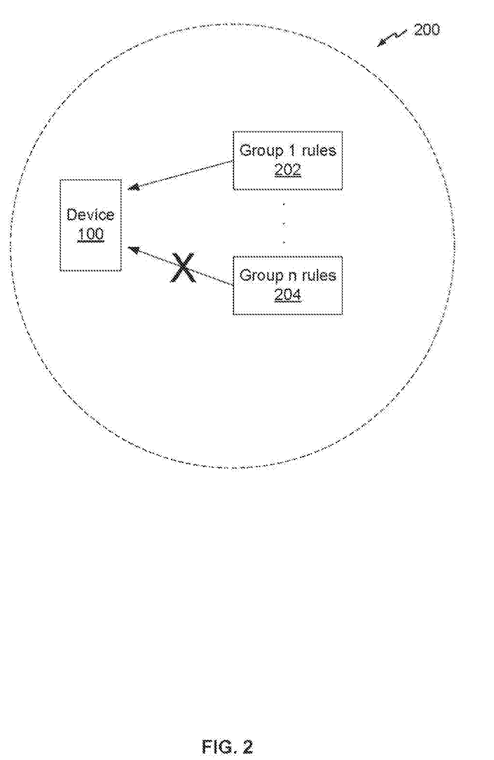

FIG. 2 illustrates the device 100 within a service area (indicated by the circle) associated with service 200, according to an example. As an example, service 200 may correspond to one of the services illustrated in FIG. 1. Upon detecting service 200 after entering the service area associated with service 200, the device 100 may communicate with the service 200 (e.g., via the agent or application installed on the device 100) and extract a set of rules that may control parameters on the device 100 if certain conditions are met, a will be further described.

As an example, the service 200 may have a number of groups, and the device 100 may be associated with one or more of the groups. Each group may have a different set of rules to control various parameters on devices associated with that particular group. Referring to FIG. 2, as device 100 may belong to a first group, the device 100 may extract rules 202 corresponding to the first group, and not extract rules 204 corresponding another group (indicated by the arrows). Although a single device is illustrated, any number of devices belonging to the various groups may enter the service area associated with service 200 and individually extract the appropriate set of rules.

As an example, in a family home, a first group may control parameters on devices registered to adults, and a second group may control parameters on devices registered to children. As a result, parameters on devices registered to children in the home may be controlled, without affecting devices registered to adults (e.g., the parents). As another example, in a museum, a first group may control parameters on devices registered to employees, and a second group may control parameters on devices registered to non-employees (e.g., visitors). As an example, a device may be associated with a particular group based on an initial registration. For example, with regards to the family home situation, if a device is to be primarily used by the children, the device may be registered to a group for controlling the children's devices. As a result, when the device registered to the children enters the service area associated with service 200, the device may extract the set of rules or controlling the children's devices.

As a device enters a service area associated with a service, and extracts an appropriate set of rules from the service, it may not be necessary to automatically apply the extracted rules to the device for controlling parameters. For example, certain conditions or criteria set for the extracted rules may have to be met for the rules to be applied to the device. Examples of such criteria may be based on location, time, special events, or a combination of conditions. For example, upon a device entering a service area associated with a service, certain parameters on the device may be enabled or disabled at a specific time of the day. As an example, referring back to the family home situation described above, although a device registered to a child may be located within the home, rules for turning off the Wi-Fi radio may only be applied at a certain time of the day (e.g., after 7 PM). Up until 7 PM, the child may be able to access the Internet on the device via the Wi-Fi radio. As mentioned above, although the Wi-Fi radio on devices belonging to children may be turned off at a certain time, the Wi-Fi radio on devices registered to another group, such as the parents, may not be affected.

Once the conditions set for the extracted rules are no longer met or satisfied by the device, the device may no longer apply the extracted rules to the device. As an example, the agent or application installed on the device may remove the extracted rules from the device. As an example, referring back to FIG. 1, as device 100 exits the service area associated with service A 102, the device 100 may no ionger apply a set of the rules 103 to the device, and may remove the set of the rules 103 from the device 100 that corresponded to service A 102. If the device 100 then enters a service area associated with another service, such as service B 105, the device 100 may then extract a set of rules 105 from service B 104, and then apply the extracted rules if certain conditions are met. The rules between the services may impact different parameters on devices, based on limitations set by an administrator of each service.

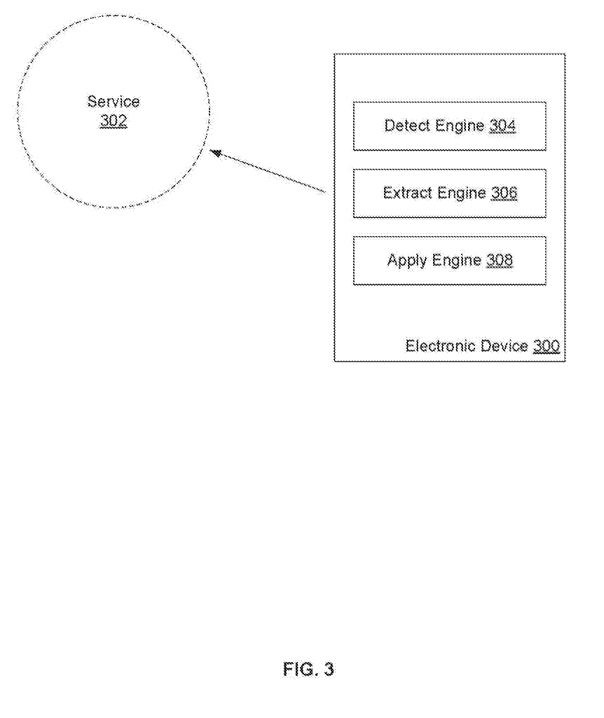

FIG. 3 depicts an example of physical and logical components for implementing various embodiments. According to an example, various components are, identified as engines 304-308. In describing engines 304-308, focus is on each engine's designated function. However, the term engine, as used herein, refers to a combination of hardware and programming configured to perform a designated function. According to an example, the hardware of each engine, for example, may include one or both of a processor and a memory, while the programing is code stored on that memory and executable by the processor to perform the designated function (e.g., refer to processor 110 and memory device 112 of device 100 in FIG. 1). The programming can include an operating system and application. In addition, the hardware of each engine can include a display and any user input buttons.

FIG. 3 is a block diagram depicting components cf an electronic device 300. As an example, electronic device 300 may correspond to device 100 from FIGS. 1-2. In this example, the electronic device 300 includes detect engine 304, extract engine 306, and apply engine 308. Detect engine 304 represents a combination of hardware and programming configured to detect a service upon entering a service area corresponding to the service. The device 300 can move in a number of directions, such as, for example, the direction indicated by the arrow. Referring to the figure, the device 300 may enter a service area corresponding to service 302, or be within range or proximity of service 302 when the device 300 enters the illustrated circle corresponding to the range of service 302. Examples of a service area include, but are not limited to, a geographical location or an area covered by an indoor positioning system, such as a beacon or a Wi-Fi access point. Referring back to FIG. 1, a device may detect service A 102 at a first geographical location, service B 104 at a second geographical location, and service C 106 at a third geographical location.

As described above, the service includes rules to control parameters on the device 300. Extract engine 306 represents a combination of hardware and programming configured to extract a set of rules from the service 302. As an example, the extracted set of rules may correspond to a group that the device 300 is associated with. Each group may have a different set of rules to control various parameters on devices associated with that particular group. For example, referring back to FIG. 2, as a device may belong to a first group, the device may extract rules 202 corresponding to the first group, and not extract rules 204 corresponding to another group (indicated by the arrows).

Apply engine 308 represents a combination of hardware and programming configured to apply the extracted set of rules to the electronic device 300, upon determining whether conditions set for the extracted set of rules are met by the electronic device 300. Examples of such conditions may be based on location, time, special events, or a combination of conditions. For example, upon the device 300 entering the service area associated with service 302, the applied rules may enable or disable certain sensors or various functions of the device 300 at a specific time of the day, such as the ringer volume, the Wi-Fi radio, or the camera. As an example, the rules may remain applied to the device 300 until the device 300 exits the service area corresponding to service 302. Once the device 300 exits the service area, or if conditions set for the extracted set of rules are no longer met by the electronic device 300, the apply engine 308 may no longer apply the extracted set of rules to the electronic device 300, and remove the extracted set of rules from the electronic device 300.

In foregoing discussion, engines 304-308 were described as combinations of hardware and programming. Engines 304-308 may be implemented in a number of fashions. Referring back to FIG. 1, the programming may be processor executable instructions stored on tangible memory device 112 and the hardware may include processor 110 for executing those instructions. Thus, memory device 112 can be said to store program instructions that, when executed by processor 110, implement the components of the communications device of FIG. 3.

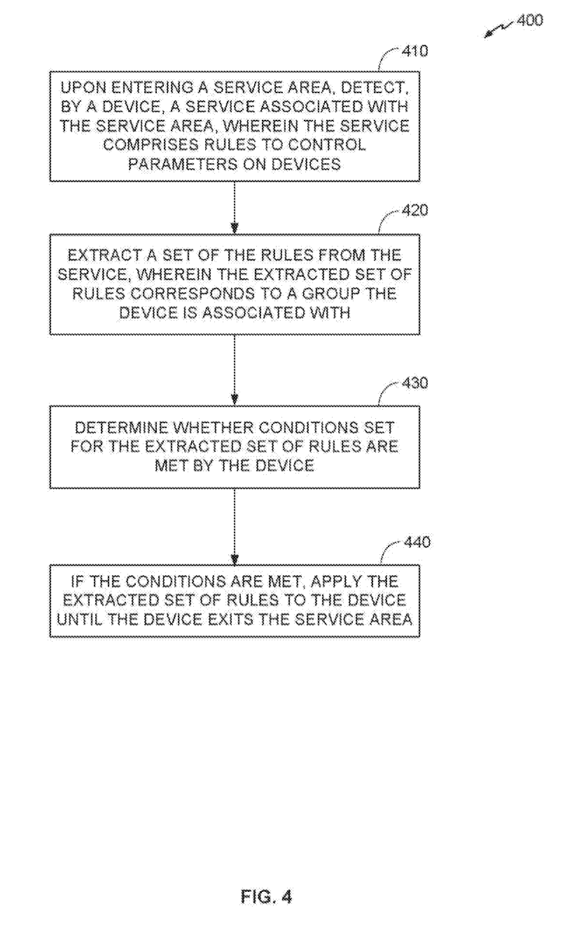

FIG. 4 is a flow diagram 400 of steps taken to implement a method for a device. The method may be implemented by an agent or an application installed on the device. In discussing FIG. 4, reference may be made to the components depicted in FIG. 3. Such reference is made to provide contextual examples and not to limit the manner in which the method depicted by FIG, 4 may be implemented.

At 410, upon entering a service area, a device may detect a service associated with the service area, wherein the service comprises rules to enable or disable parameters on devices. Examples of a service area include, but are not limited to, a geographical location or an area covered by an indoor positioning system, such as a beacon or a Wi-Fi access point. The device may enter the service area once coming within proximity of the geographical location, or within range of the beacon transmission or Wi-Fi access point coverage. Referring back to FIG. 1, the device may detect service A 102 at a first geographical location, service B 104 at a second geographical location, and service C 106 at a third geographical location. As illustrated, each service may be located in different geographical locations. However, certain services may also overlap (not illustrated). Referring back to FIG. 3, detect engine 304 may be responsible for implementing step 410.

As described above, the service includes rules to control parameters on the device. At 420, the device may extract a set of the rules from the service. As an example, the extracted set of rules may correspond to a group that the device is associated with. Each group may have a different set of rules to control various parameters on devices associated with that particular group. For example, referring back to FIG. 2, as a device may belong to a first group, the device may extract rules 202 corresponding to the first group, and not extract rules 204 corresponding to another group (indicated by the arrows). Referring again to FIG. 3, extract engine 306 may be responsible for extracting the set of rules from a service.

At 430, the device may determine whether conditions set for the extracted set of rules are met by the device. Examples of such conditions may be based on location, time, special events, or a combination of conditions. For example, the conditions set for the extracted set of rules may correspond to whether the device is geographically located in a particular location, and/or whether it is a particular time of the day.

At 440, if conditions are met, the device applies the extracted set of rules to the device until the device exits the service area. As an example, upon applying the extracted set of rules, certain parameters on the device may be turned off or on. Examples of parameters that may be controlled by the service include, but are not limited to, sensors or various functions of the devices that may be enabled or disabled, such as a Wi-Fi radio or a camera.

As an example, if the conditions set for the extracted set of rules are met by devices associated with another group that is different from the group the device is associated with, parameters of the devices associated with the other group are not affected. For example, referring to the family home situation described above, although the Wi-Fi radio on devices belonging to children may be turned off at a certain time, the Wi-Fi radio on devices belonging to another group, such as the parents, may not be affected.

Once the conditions set for the extracted set of rules are no longer met by the device, the device may no longer apply the extracted set of rules to the device, and may remove the extracted set of rules from the device. Referring again to FIG. 3, apply engine 308 may be responsible for implementing steps 430 and 440.

Although the flow diagram of FIG. 4 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is;

1. A method comprising:
upon entering a service area, detecting, by a device, a service associated with the service area, wherein the service comprises rules to enable or disable parameters on devices;
extracting, a set of the rules from the service, wherein the extracted set of rules corresponds to a group the device is associated with;
determining whether conditions set for the extracted set of rules are met by the device; and
if the conditions are met, applying the extracted set of rules to he device until the device exits the service area.

2. The method of claim 1, wherein detecting comprises:
detecting a first service upon entering a first service area; and
detecting a second service upon entering a second service area located at a different geographical location from the first service area.

3. The method of claim 1, wherein, once the conditions set for the extracted set of rules are no longer met by the device:
no longer applying the extracted set of rules to the devic; and
removing the extracted set of rules from the device.

4. The method of claim 1, wherein, if the conditions set for the extracted set of rules are met by devices associated with another group that is different from the group the device is associated with, parameters of the devices associated with the other group are not affected.

5. The method of claim 1, wherein tine conditions set for the extracted set of rules correspond to whether the device is geographically located in a particular location.

6. The method of claim 5, wherein the conditions set for the extracted set of rules correspond to a time of day.

7. The method of claim 1, wherein applying the extracted set of rules comprises turning off or on certain parameters on the device.

8. An electronic device comprising:
upon entering a service area, a detect engine to detect a service associated with the service area, wherein the service comprises rules to control parameters on electronic devices;
an extract engine to extract a set of the rules from the service, wherein the extracted set of rules corresponds to a group the electronic device is associated with; and
until the device exits the service area, an apply engine to apply the extracted set of rules to the electronic device, if conditions set for the extracted set of rules are met by the electronic device.

9. The electronic device of claim 8, wherein, once the conditions set for the extracted set of rules are no longer met by the electronic device, the apply engine is to:
no longer apply the extracted set of rules to the electronic device; and
remove the extracted set of rules from the electronic device.

10. The electronic device of claim 8, wherein the conditions set for the extracted set of rules correspond to whether the electronic device is geographically located in a particular location.

11. The electronic device of claim 10, wherein the conditions set for the extracted set of rules correspon to a time of day.

12. The electronic device of claim 8, wherein the apply engine applying the extracted set of rules comprises turning off or on certain parameters on the electronic device.

13. A non-transitory computer-readable storage medium comprising programming instructions which, when executed by a processor, to cause a device to:
detect a service comprising rules to control parameters on devices;
extract a set of the rules from the service, wherein the extracted set of rules corresponds to a group the device is associated with;
determine whether conditions set for the extracted set of rules are met by the device, wherein the conditions set for the extracted set of rules correspond to whether the device is geographically located in a particular location; and
if the conditions are met, apply the extracted set of rules to the device until the device is no longer geographically located in the particular location.

14. The non-transitory computer-readable storage medium of claim 13, wherein the instructions to cause the device to detect comprises instructions to:
detect a first service at a first geographical location; and
detect a second service at a second geographical location different from the first geographical location.

15. The non-transitory computer-readable storage medium of claim 13, wherein the instructions to cause the device to apply the extracted set of rules comprises instructions to turn off or on certain parameters on the device.
